(19) United States
(12) Patent Application Publication
(10) Pub. No.: US 2007/0146760 A1
(43) Pub. Date: Jun. 28, 2007

(54) Print System and Programs for Use in Print System

(75) Inventor: Masao Takatsu, Nagoya-shi, Aichi-ken (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 11/616,340

(22) Filed: Dec. 27, 2006

(30) Foreign Application Priority Data
Dec. 28, 2005 (JP) 2005-380142

(51) Int. Cl. G06F 3/12

(52) U.S. Cl. 358/1.13; 358/1.15

(57) ABSTRACT

A print system in which a user can change parameters at the time of reprinting is provided. Also provided are a method for use in a print system and one or more computer readable storage media having computer-executable instructions for use in a print system which allow parameters to be changed for an image to be reprinted.

### CROSS REFERENCE TO RELATED APPLICATION

This application claims priority from Japanese Patent Application No. 2005-380142, filed on Dec. 28, 2005, the entire subject matter of which is incorporated herein by reference.

### FIELD

Aspects of the invention relate to a print system and programs for use in the print system.

### BACKGROUND

In a known print system, a spool file is generated for each print job, based on print instructions from applications software. The spool file is temporarily stored in a storage device, such as a hard disk. The stored spool file is output to a printer in accordance with an operating state of the printer. Such a print system is executed as a function of an operating system (OS) that is executed on a PC (personal computer).

When a print instruction is provided from an application, which is activated on the PC, with a user's operation, the print instruction is transmitted, via a Windows®XP's printer driver, to a graphics device interface (GDI), which is a program module provided by Windows®XP. With the GDI, a device context (hereinafter, referred to as the “DC”) serving as a virtual display area is created and provided to the application. The application performs a drawing process on the DC. A printer-independent enhanced metafile (EMF file) is generated for each page.

According to print jobs, the EMF file for each page is temporarily stored (spooled) as a spool file in a storage device by a spooler system. A print processor controls a printer driver to convert the spool file stored in the storage device into a printer control code in association with output printers. The printer control code is output to the printer.

To reprint a spool file, the spool file may be processed. For example, as described in Japanese Laid-Open Patent Publication No. 8-30413, specific codes are inserted or embedded in the spool file in association with each page break. By inputting a page number or a page range to be printed, the page or pages are searched with the inserted or embedded codes as a key. Thus, the page or pages are reprinted.

### SUMMARY

According to aspects of the invention, a print system in which a user can readily change parameters at the time of reprinting and a program for use in the print system are provided.

### BRIEF DESCRIPTION OF THE DRAWINGS

Illustrative aspects of the invention will be described in detail with reference to the following figures wherein:

FIG. 1 is a schematic showing general configuration of a print system according to an illustrative aspect of the invention;

FIG. 2 is a flowchart of a printing process;

FIG. 3 is a flowchart of a print setting process;

FIG. 4 is a flowchart of a job management process;

FIG. 5 is a flowchart of a reprinting process;

FIG. 6 is a flowchart of a deleting process;

FIG. 7 is a flowchart of a background printing process;

FIG. 8 is an example of management data;

FIG. 9A is a schematic showing an example of a print setting dialog box;

FIG. 9B is a schematic showing an example of a job management dialog box; and

FIG. 10 is a schematic showing another example of the job management dialog box.

### DETAILED DESCRIPTION

Aspects of the invention will be described in detail with reference to the accompanying drawings.

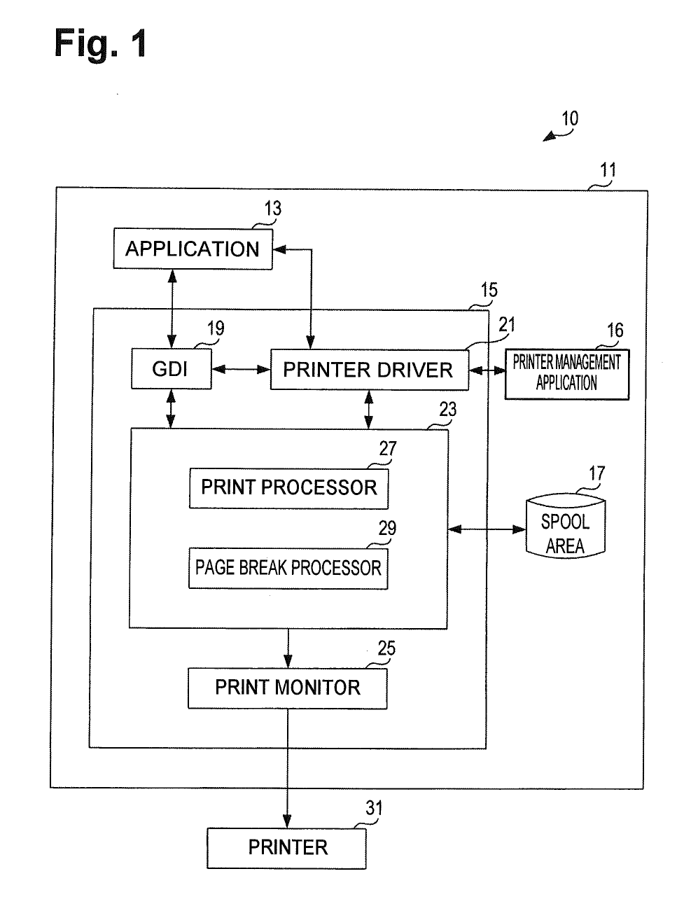

As shown in FIG. 1, a print system 10 according to an illustrative aspect of the invention includes a personal computer (PC) 11, and a printer 31. In FIG. 1, only one PC 11 and one printer 31 are shown. However, a plurality of the PCs and a plurality of the printers 31 may be provided.

The PC 11 is a generally known personal computer. The PC 11 includes a central processing unit (CPU), a read-only memory (ROM), a random access memory (RAM), an input/output (I/O), a hard disk, a display, a keyboard, and mouse. Various programs including computer-executable instructions are stored in memory, such as on the hard disk. It will be appreciated that one or more known types of storage media may be employed including, but not limited to, optical storage, magnetic storage and removable storage such as flash memory. The programs are read out into the RAM. The CPU performs various processing. A spool area 17 for storing a spool file is provided in the hard disk. The spool area 17 includes a folder 1 and a folder 2. In the folder 1, a spool file to be printed is stored. In the folder 2, a printed spool file is stored.

Programs relating to aspects of the invention and to be read out into the RAM of the PC 11 will be described below. The print system 10 includes an application 13, an operating system (OS) 15, and a printer management application 16. The OS 15 includes a graphics device interface (GDI) 19, a printer driver 21, a spooler 23, and a print monitor 25. The spooler 23 includes a print processor 27 and a page break processor 29.

The application 13 includes applications software, such as word processing software and spreadsheet software that operate under the control of the OS 15. The application 13 is configured to receive a print instruction from a user. When the application 13 receives a print instruction from a user, data created on the application 13 is transferred to the OS 15.

The GDI 19 receives the data from the application 13. Based on the data received from the application 13, the GDI 19 generates, in cooperation with the printer driver 21, a device-independent enhanced metafile (EMF file) for each page.

The printer driver 21 includes a printer-independent common function, which is provided as a standard function of the OS 15, and a specific function, which is provided according to the types of printers (e.g., converting data to be printed to the form specific to a printer). The printer driver 21 executes those functions, in cooperation with the application 13, the GDI 19, the spooler 23, and the printer management application 16.

The spooler 23 includes the print processor 27 and the page break processor 29. The print processor 27 combines the EMF file for each page transferred from the GDI 19 into a spool file. The spool file is stored in the spool area 17. One spool file is associated with one print job. The spool file stored in the spool area 17 is converted into a printer control code that can be used by the printer 31 in cooperation with the printer driver 21. More specifically, the printer driver 21 calls an application program interface (API) of the OS 15 to generate a raster image in a virtual display area (device context or DC), based on the EMF file. The printer control code specific to the printer 31 is generated based on the raster image. Thus, all EMF files are converted into the printer control code. The print processor 27 transfers the printer control code to the page break processor 29. The page break processor 29 adds a page break to the relevant part of the printer control code when a page break is inserted. Then, the printer control code is transferred to the print monitor 25. The print monitor 25 transmits the printer control code, which is transferred from the page break processor 29, to the printer 31.

The printer management application 16 displays a user interface such as a dialog box on a display of the PC 11 for making printer driver 21 settings, or transfers to the printer driver 21 information relating to settings made by a user. The printer management application 16 displays information of the spool files managed by the spooler 23 by obtaining the information via the printer driver 21. The printer management application 16 also displays a dialog box to delete a spool file and performs a deletion instruction received from a user.

Next, the printer 31 will be described. The printer 31 is a generally known device having a printing function, such as an inkjet printer, dye-sublimation printer or laser beam printer. The printer 31 is configured to print based on a printer control command transmitted from the OS 15.

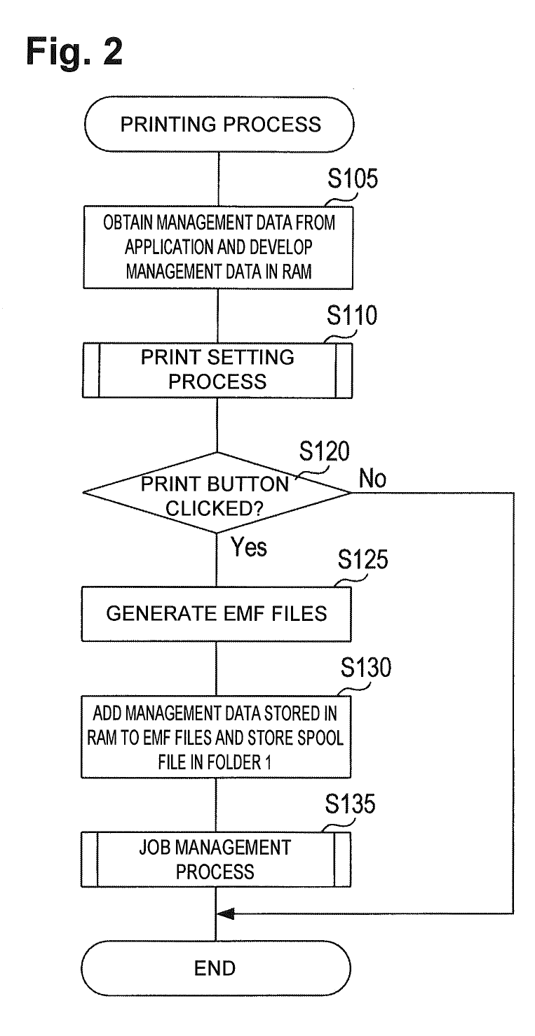

Processes performed by the CPU of the PC 11 based on program modules will be described with reference to FIGS. 2-10. The processes are mainly provided by the printer driver 21 and the printer management application 16.

A printing process will be described with reference to FIG. 2. This process is started when a user operates an application using the mouse and keyboard (not shown) and provides a print instruction.

When the CPU of the PC 11 starts the printing process, the CPU obtains management data from the application 13 and develops the job ticket in the RAM (S105). The management data is a comprehensive job information form containing all pertinent job requirements (parameters).

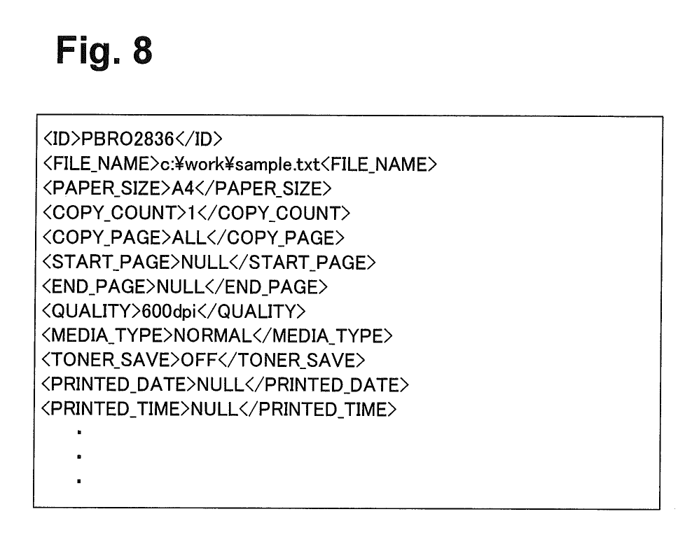

The management data will be described in detail below with reference to FIG. 8. The management data is written in extensible markup language (XML). The management data includes information regarding a print job ID as defined in “ID” tag; information regarding a name of a file to be printed as defined in “FILE_NAME” tag; information regarding a paper size as defined in “PAPER_SIZE” tag; information regarding the number of copies as defined in “COPY_COUNT” tag; information regarding pages to be printed as defined in “COPY_PAGE” tag; information regarding a print start page as defined in “START_PAGE” tag; information regarding a print end page as defined in “END_PAGE” tag; information regarding print quality as defined in “QUALITY” tag; information regarding paper type as defined in “MEDIA_TYPE” tag; ON/OFF information regarding a toner save mode as defined in “TONER_SAVE” tag; information regarding the day when printing is performed as defined in “PRINTED_DATE” tag; and information regarding the time when printing is performed as defined in “PRINTED_TIME” tag. The printed time may be the time when the printer 31 finishes printing or the time when the print instruction is provided to the printer 31.

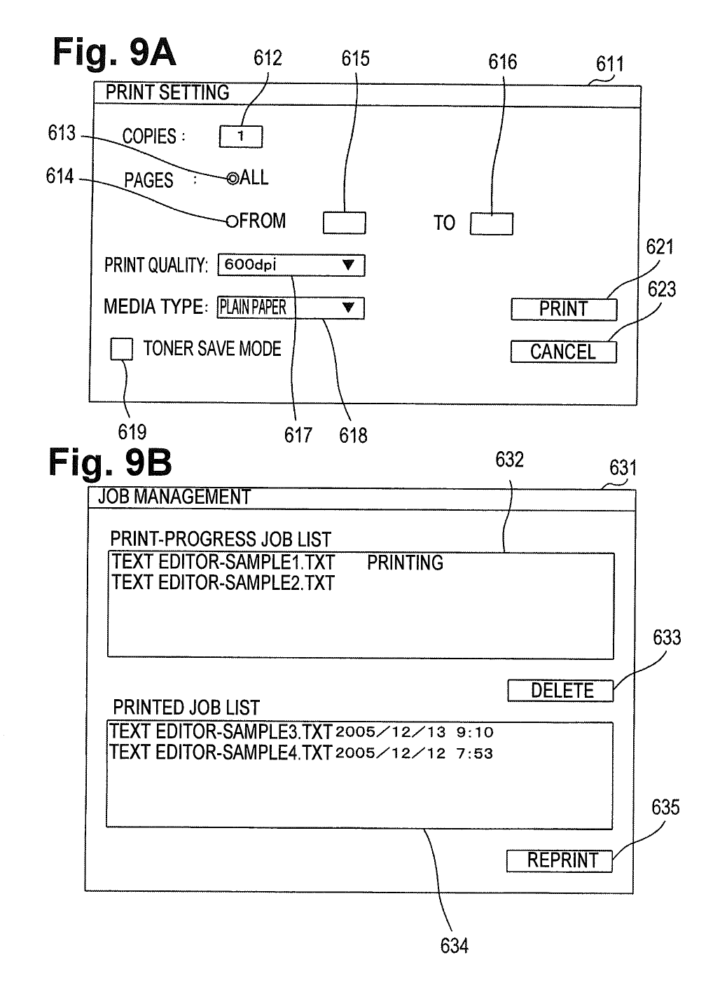

Referring back to FIG. 2, in S110, a print setting process is performed. The print setting process is performed to display a user interface such as a print setting dialog box 611 as shown in FIG. 9A in the display of the PC 11, accept operations of a user relating to print settings, and update the management data in the RAM. The print setting process and the print setting dialog box 611 will be described in detail below.

When the print setting process ends, the CPU determines whether a print button 621 in the print setting dialog box 611 is clicked (S120). When the CPU determines that the print button 621 is clicked (S120: Yes), flow proceeds to S125. When the CPU determines that the print button 621 is not clicked, that is, a cancel button 623 is clicked (S120: No), the printing process ends.

When the CPU determines that the print button 621 in the print setting dialog box 611 is clicked (S120: Yes), data received from the application 13 is converted to generate the EMF files (S125).

In S130, the management data stored in the RAM is added to the EMF files generated in S125, to generate a spool file. In other words, the spool file includes the EMF files and the management data. The spool file is stored in the folder 1 in the spool area 17.

In S135, a job management process is performed. The process is performed to display user information in a user interface such as a job management dialog box showing information relating to a print job and to start a background printing process. The job management process and the background printing process will be described in detail below.

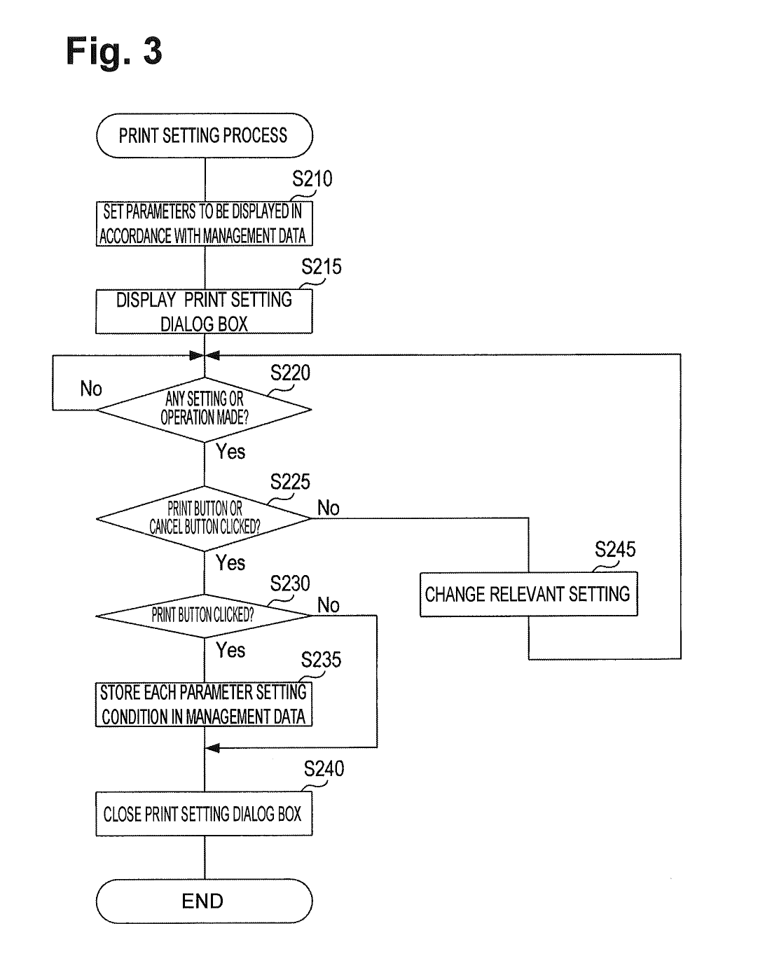

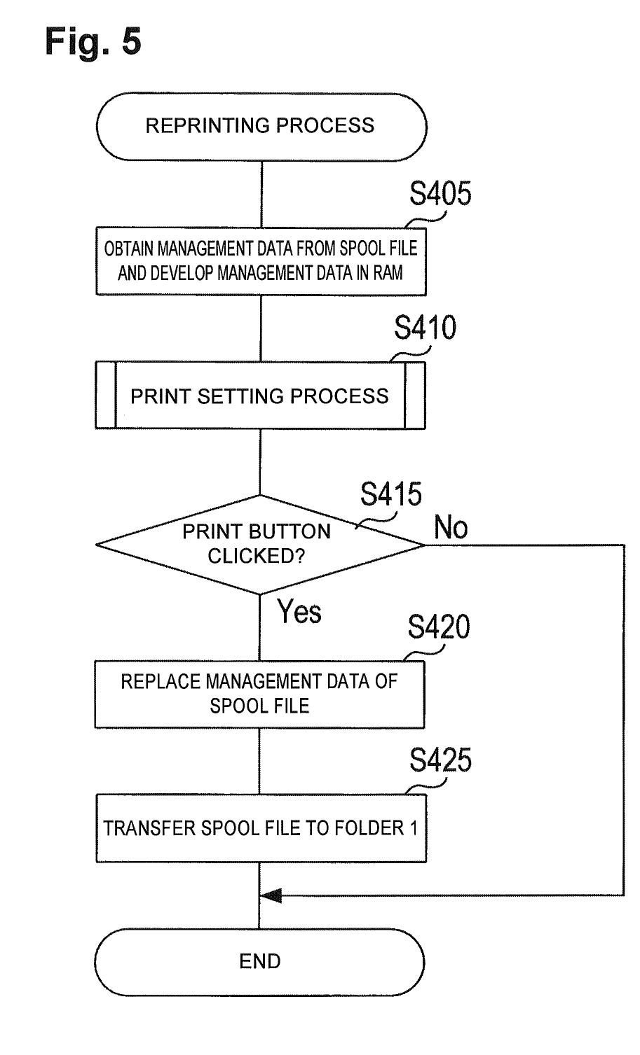

Referring to FIG. 3, the print setting process will be described. The process is performed in S110 of the printing process in FIG. 2 and in S410 of a reprinting process in FIG. 5.

When the CPU of the PC 11 starts the print setting process, parameters to be displayed on the print setting dialog box 611 in S215 are set in accordance with the management data in the RAM (S210). Then, flow proceeds to S215.

In S215, the print setting dialog box 611 is displayed in the display of the PC 11 based on the settings made in S210.

The print setting dialog box 611 will be described in detail below. A user can input or select various information in the print setting dialog box 611. As shown in FIG. 9A, the print setting dialog box 611 includes a copy setting box 612 for designating the number of copies to be made by printing, an option button 613 for setting the number of pages to be printed to “ALL”, an option button 614 for designating any pages to be printed, a start page setting box 615 for inputting a print start page, an end page setting box 616 for inputting a print end page, a drop-down list 617 for designating a print quality, a drop-down list 618 for designating a media type (paper type), a check box 619 for turning a toner save mode on or off, the print button 621 for starting the print operation, and the cancel button 623 for cancelling print settings. When the option button 614 is selected to designate specific pages to be printed, numeric characters can be input in the start page setting box 615 and the end page setting box 616.

Referring back to FIG. 3, in S220, the CPU determines whether any setting or operation, such as inputting the print start and end pages and clicking on the print button 621, is made in the print setting dialog box 611. When the CPU determines that any setting or operation is made in the print setting dialog box 611 (S220: Yes), flow proceeds to S225. When the CPU determines that no setting or operation is made in the print setting dialog box 611 (S220: No), the CPU repeats the determination in S220 as to whether any setting or operation is made in the print setting dialog box 611.

In S225, the CPU determines whether the print button 621 or the cancel button 623 is clicked. When the CPU determines that the print button 621 or the cancel button 623 is clicked (S225: Yes), flow proceeds to S230. When the CPU determines that the print button 621 or the cancel button 623 is not clicked (S225: No), flow proceeds to S245.

In S245, the relevant setting is changed according to the user's operation. For example, a drop-down list 617 for setting print quality is accessible by a user to designate the print quality to “400 dpi”. When accessed, the indication of print quality on the print setting dialog box 611 can be changed accordingly.

In S230, the CPU then determines which button, the print button 621 or the cancel button 623 is clicked. When the CPU determines that the print button 621 is clicked (S230: Yes), flow proceeds to S235. When the CPU determines that the print button 621 is not clicked, that is, the cancel button 623 is clicked (S230: No), flow proceeds to S240.

In S235, each parameter setting condition in the print setting dialog box 611 is stored in the management data in the RAM. For example, when the number of copies to be printed is set to “10” in the copy setting box 612, the number of copies as defined in “COPY_COUNT” tag is changed to “10”.

As each parameter setting condition is stored in the management data in the RAM, flow proceeds to S240. In S240, the print setting dialog box 611 displayed in the display of the PC 11 is closed. The print setting process ends and flow continues to S120 of the printing process in FIG. 2 or S415 of the reprinting process in FIG. 5.

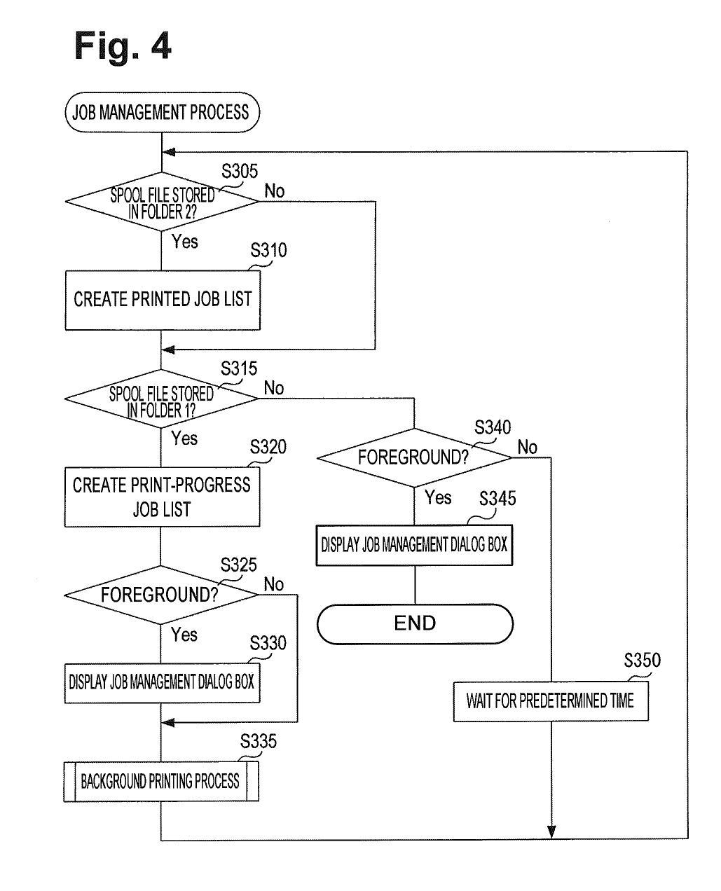

A job management process will be described in detail below with reference to FIG. 4. This process is started in S135 of the printing process in FIG. 2 or when a user selects the process from a menu of the OS 15.

When the job management process is executed, the CPU determines whether a spool file is stored in the folder 2 of the spool area 17. As described above, printed spool files are stored in the folder 2. When the CPU determines that the spool file is stored in the folder 2 (S305: Yes), flow proceeds to S310. When the CPU determines that the spool file is not stored in the folder 2 (S305: No), flow proceeds to S315.

In S310, a printed job list is created that is to be shown in a user interface such as job management dialog box 631 shown in FIG. 9B.

The job management dialog box 631 will be described in detail below with reference to FIG. 9B. The job management dialog box 631 includes a print-progress job list box 632, a delete button 633, a printed job list box 634, and a reprint button 635. The print-progress job list box 632 lists information of print jobs in progress including a currently printing job and any jobs in the print queue. The delete button 633 is clicked to delete a print queue job listed in the print-progress job list box 632 and selected by a user. The printed job list box 634 lists information of printed jobs. The reprint button 635 is clicked to re-execute a job listed in the printed job list box 634 and selected by a user. The print jobs in progress and the printed job may be represented by characters and/or icons.

Information listed for each job in the print-progress job list box 632 can include an application name, a print file name, and a printing status, which can be shown when a job is currently being printed.

Information listed in the printed job list box 634 can include an application name, a printed file name and a printed date and time. The information can be displayed according to the printed jobs using management data information. When a user clicks on the delete button 633, a deleting process (described below) is started. When a user clicks on the reprint button 635, a reprinting process (described below) is started.

As the information of print-progress print jobs and printed jobs, a name of a user (owner) who executes printing, the number of print pages, and print data size may be additionally shown in the print-progress job list box 632 and the printed job list box 634.

Referring back to FIG. 4, when the printed job list is created (S310), the CPU determines whether a spool file is stored in the folder 1 of the spool area 17 (S315). When the CPU determines that the spool file is stored in the folder 1 (S315: Yes), flow proceeds to S320. When the CPU determines that the spool file is not stored in the folder 1 (S315: No), flow proceeds to S340.

In S320, a print-progress job list is created to show the list in the job management dialog box 631.

In S325, the CPU determines whether the job management process is performed as a foreground process. A foreground process is performed with the job management dialog box 631 displayed on the display of the PC 11. A background process is performed behind the scenes without the job management dialog box 631 being displayed.

When the CPU determines that the job management process is performed as a foreground process (S325: Yes), flow proceeds to S330. When the CPU determines that the job management process is not performed as the foreground process (S325: No), that is, the process is performed as a background process, flow proceeds to S335.

In S330, the job management dialog box 631 showing the job list is displayed in the display of the PC 11. Then, flow proceeds to S335 where a background printing process is performed.

In the background printing process, the printer 31 performs printing using a spool file stored in the folder 1. The background printing process will be described in detail below. As the background printing process ends, flow returns to S305.

In S340, the CPU determines whether the job management process is performed as a foreground process. When the CPU determines that the job management process is performed as a foreground process (S340: Yes), flow proceeds to S345.

In S345, the job management dialog box 631 is displayed in the display of the PC 11 and the job management process ends. When the job management process is started in S135 of the printing process in FIG. 2, flow proceeds to the next step to end the printing process.

When the CPU determines that the job management process is not performed as a foreground process (S340: No), that is, the job management process is performed as a background process, flow proceeds to S350.

In S350, the process waits a predetermined period of time (e.g., one second). Then, flow returns to S305.

A reprinting process will be described with reference to FIG. 5. The reprinting process is started when a user selects a printed job from the printed job list using, for example, a mouse and clicks on the reprint button 635 in the job management dialog box 631 as shown in FIG. 9B. More specifically, the OS 15 detects whether the reprint button 635 is clicked. The OS 15 transfers the detection result to a program relevant to the reprinting process (the printer driver 21 or the printer management application 16), to start the reprinting process.

When the CPU of the printer 11 starts the reprinting process, management data is obtained from the spool file, which is stored in the folder 2 of the spool area 17 and corresponds to the printed job selected by a user. The management data is developed in the RAM (S405).

In S410, the print setting process, as shown in FIG. 3, is performed with the management data developed in the RAM in S405 as initial settings. During the print setting process, the CPU receives print settings made by a user and updates the management data in the RAM.

As the print setting process ends, the CPU determines whether the print button 621 of the print setting dialog box 611 is clicked during the print setting process (S415). When the CPU determines that the print button 621 is clicked (S415: Yes), flow proceeds to S420. When the CPU determines that the print button 621 is not clicked (S415: No), that is, the cancel button 623 is clicked, the reprinting process ends.

In S420, the management data, obtained in S405, of the spool file is replaced with the management data containing parameters for reprinting.

In S425, the spool file corresponding to the reprinting operation and stored in the folder 2 of the spool area 17 is transferred to the folder 1. Then, the reprinting process ends.

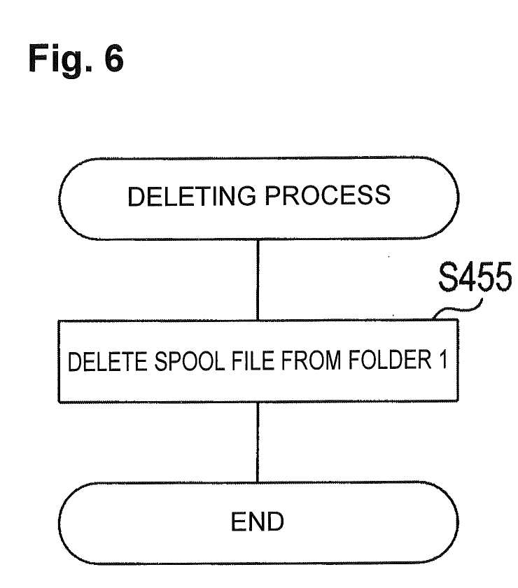

A deleting process will be described with reference to FIG. 6. The deleting process is started when a user selects a job in the print queue listed in the print-progress job list box 632 and clicks on the delete button 633 in the job management dialog box 631 as shown in FIG. 9B. More specifically, the OS 15 detects whether the delete button 633 is clicked. The OS 15 transfers the detection result to a program relevant to the deleting process (the printer driver 21 or the printer management application 16).

When the CPU of the PC 11 starts the deleting process, the spool file corresponding to the print queue job is deleted from the folder 1 (S455). Accordingly, the print queue job listed in the print-progress job list box 632, as shown in FIG. 9B, is deleted. As the deletion of the spool file is complete, the deleting process ends.

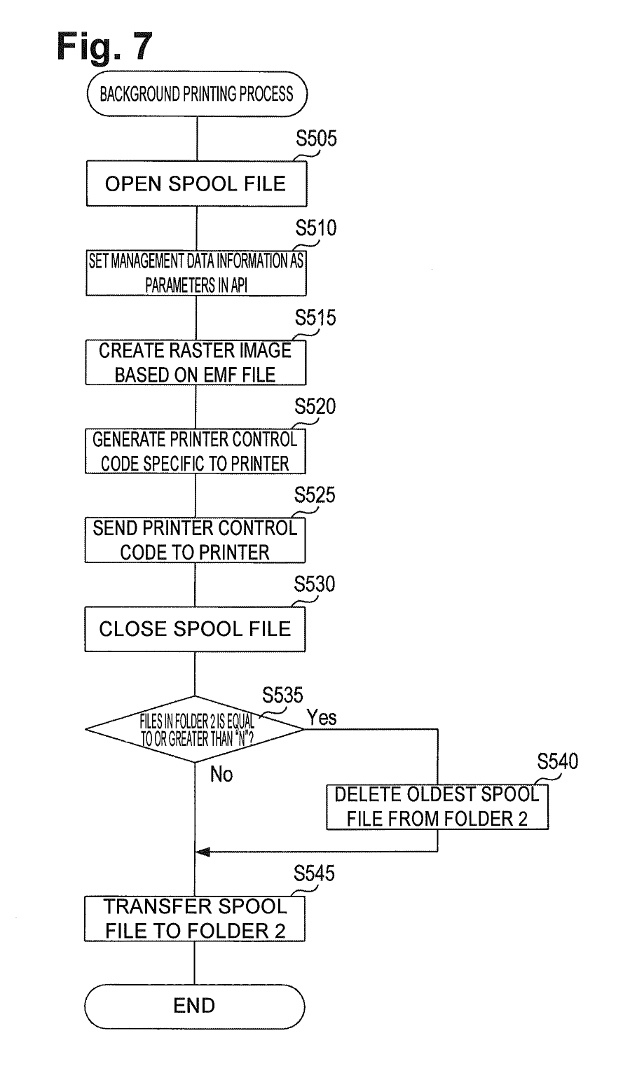

A background printing process will be described with reference to FIG. 7. The background printing process is started in S335 of the job management process, as shown in FIG. 4.

When the CPU of the PC 11 starts the background printing process, the CPU opens one spool file stored in the folder 1 of the spool area 17 (S505). The CPU reads the management data of the spool file opened in S505. The management data information is set as parameters in the API (S510).

In S515, the CPU reads the EMF files of the spool file. The printer driver 21 calls the API to generate a raster image of the virtual display area (DC) based on the EMF files.

In S520, the printer control code specific to the printer 31 is generated based on the raster image generated in S515.

In S525, the printer control code generated in S525 is transmitted to the printer 31. As the transmission of the printer control code is complete, the spool file opened in S505 is closed in S530.

In S535, the CPU determines whether the number of the spool files stored in the folder 2 of the spool area 17 is equal to or greater than a predetermined number “n” (e.g., n =10). The predetermined number “n” may be determined based on the relation between an average spool file size and the memory area for storing the spool files. When the CPU determines that the number of the spool files in the folder 2 is equal to or greater than “n” (S535: Yes), flow proceeds to S540.

When the CPU determines that the number of the spool files in the folder 2 is not equal to or greater than “n” (S535: No), flow proceeds to S545.

In S540, one of the spool files, stored in the folder 2, with the oldest print date and time is selected and deleted from the folder 2. Then, flow proceeds to S545.

In S545, the spool file closed in S530 is moved from the folder 1 to the folder 2. Then, the background printing process ends and flow returns to the job management process in FIG. 4.

In the background printing process, after the CPU determines whether the number of the spool files in the folder 2 is equal to or greater than “n”, the spool file in the folder 1 is moved to the folder 2. However, after the spool file in the folder 1 is moved to the folder 2, the CPU may determine whether the number of the spool files in the folder 2 is equal to or greater than “n”.

When a file is reprinted, the last printing parameters (management data information) of the file are set as initial settings (see S210 in FIG. 3) and are displayed in the print setting dialog box 611 on the display of the PC 11. A user may change parameters when reprinting with reference to those displayed in the print setting dialog box 611. If parameters do not have to be changed from the last printing parameters when reprinting, a user may start reprinting without changing any parameters. A user does not have to keep the last printing parameters in mind when setting parameters for reprinting. Thus, the user may readily obtain his/her intended print output.

When the spool file is stored in the folder 2 of the spool area 17, the CPU determines in S535 whether the number of the spool files stored in the folder 2 is equal to or greater than the predetermined number “n”. When the CPU determines that the number of the spool file stored in the folder 2 is equal to or greater than “n” (S535: Yes), one of the spool files, stored in the folder 2, with the oldest print date and time is deleted from the folder 2 (S540). Thus, the number of the spool files stored in the folder 2 may not become greater than “n”. With such a structure, the area allocated for the folder 2 may not be occupied completely with the printed spool files.

The job management dialog box 631 as shown in FIG. 9B includes the print-progress job list box 632 for listing information for print jobs in progress and the printed job list box 634 for listing information for printed jobs. While viewing the information listed in the boxes 632, 634, a user may readily understand the printing job, print queue jobs, and re-printable jobs.

As shown in FIG. 9B, in the printed job list box 634 where information for the printed jobs is listed, the last printed date and time of a printed job is indicated. With such a structure, a user may select a printed job with reference to its printed date and time and reprint a job that was printed immediately before the reprinting is performed.

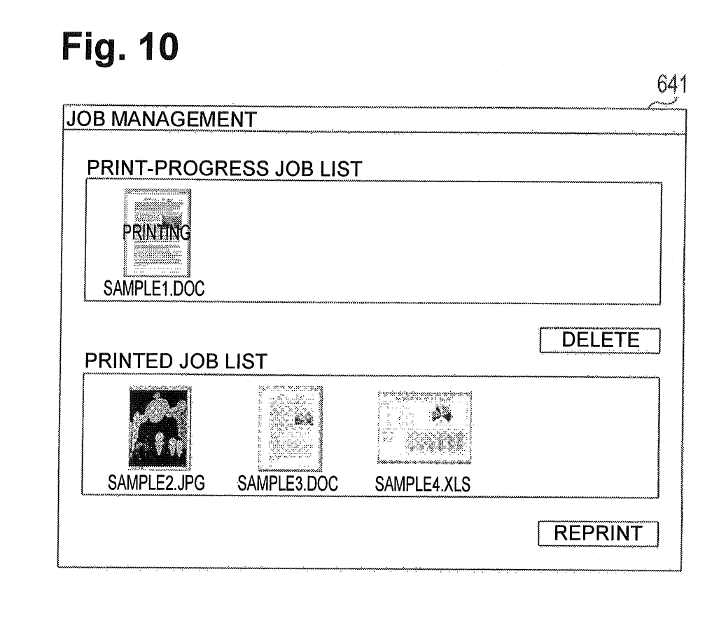

FIG. 10 shows another example of a user interface in the form of a job management dialog box 641. Information for print-progress or printed jobs may be represented by a thumbnail (reduced-size version of picture) of, for example, the first page of a document, rather than represented by characters. With the thumbnails (reduced-size version of picture), documents that are to be printed or that have been printed may be readily recognized. Therefore, possibilities of mistakenly printing different documents than a user intends may be reduced.

A delete check box may be provided in the print setting dialog box 611. If the delete check box is turned on when the CPU receives a print command from a user, the CPU may delete the spool file corresponding to the print command from the spool area 17 after printing is performed and the spool file is closed in S530 (in FIG. 7). With such a structure, if it is desired that the same file not be printed any more, the delete check box may be turned on. Thus, the spool file of the print job may not be stored in the spool area 17. Accordingly, the storage area in the spool area 17 may be effectively used.

In the job management dialog box 631, when a printed job is selected and dragged with a user's mouse operation from the printed job list box 634 and then dropped onto the print-progress job list box 632, the spool file corresponding to the dragged-and-dropped print job may be moved from the folder 2 to the folder 1 of the spool area 17 immediately after the drag-and-drop operation. Thus, a user can readily provide a reprint instruction. With such a structure, convenience to a user may increase.

Management data is included in a spool file. However, management data may be separated from a spool file. Even when the management data and the spool file are separated from each other, the above-described aspects will be achieved.

In addition to the above-described parameters, other parameters regarding paper size, double-sided printing, multiple printing in a single sheet (which is called “N in 1”, such as, 4 in 1 and 2 in 1), monochrome/color printing, color balance and toner density, may be changed.

While the invention has been described in connection with various example structures and illustrative aspects, it will be understood by those skilled in the art that other variations and modifications of the structures and aspects described above may be made without departing from the scope of the invention. Other structures and aspects will be apparent to those skilled in the art from a consideration of the specification or practice of the invention disclosed herein. It is intended that the specification and the described examples are illustrative with the true scope of the invention being defined by the following claims.

What is claimed is:

1. One or more computer readable storage media for use in a print system including processor, a print device, a display device and a storage device, the computer readable storage media having computer executable instructions stored thereon, which when executed by the processor, perform the steps comprising:
receiving a print request;
accepting a first print parameter associated with the print request;
generating a spool file based on the print request;
storing the spool file and the first print parameter in the storage device;
printing a first image, using the print device, based on the spool file and the first print parameter;
receiving a reprint request for printing a second image based on the spool file stored in the storage device;
retrieving the first print parameter from the storage device;
displaying the first print parameter in the display device;
determining a second print parameter based on the first print parameter, the second print parameter being associated with the reprint request; and
printing the second image, using the print device, based on the second print parameter and the spool file.

2. The computer readable storage media according to claim 1, further including the step of modifying the first print parameter in response to a user input to produce the second print parameter.

3. The computer readable storage media according to claim 2, further including the step of providing a setting interface on the display device to receive the user input.

4. The computer readable storage media according to claim 3, further including the step of displaying the first print parameter in the setting interface in response to receiving the reprint request.

5. The computer readable storage media according to claim 1, wherein storing the spool file and the first print parameter is performed after deleting an oldest spool file and a first print parameter corresponding to the oldest spool file from the storage device when the number of spool files stored in the storage device is equal to or greater than a predetermined number.

6. The computer readable storage media according to claim 1, further including the step of deleting the spool file and the first print parameter from the storage device after printing in response to receiving a delete request when the print request has been received.

7. The computer readable storage media according to claim 1, further including the step of deleting the spool file and the second print parameter from the storage device after printing in response to receiving a delete request when the reprint request has been received.

8. The computer readable storage media according to claim 1, further including the step of displaying a job interface including a first area and a second area in the display device, wherein the first area is configured to display information for a print job in a print queue and the second area is configured to display information for printed jobs.

9. The computer readable storage media according to claim 8, further including the step of displaying the first print parameter in the display device when an object representing the printed job is dragged from the second area and dropped into the first area.

10. The computer readable storage media according to claim 8, wherein the step of receiving the reprint request includes receiving user input dragging the printed job from the second area and dropping the printed job in the first area.

11. The computer readable storage media according to claim 8, wherein the information displayed in the second area includes a print date and time for the printed job.

12. A method for reprinting in a print system including a printing device, a display device and a storage device, comprising:
receiving a print request;
accepting a first print parameter associated with the print request;
generating a spool file based on the print request;
storing the spool file and the first print parameter in the storage device;
printing a first image, using the print device, based on the spool file and the first print parameter;
receiving a reprint request for printing a second image based on the spool file stored in the storage device;
retrieving the first print parameter from the storage device;
displaying the first print parameter in the display device;
determining a second print parameter based on the first print parameter, the second print parameter being associated with the reprint request; and
printing the second image, using the print device, based on the second print parameter and the spool file.

13. The method according to claim 12, further including the step of modifying the first print parameter in response to a user input to produce the second print parameter.

14. The method according to claim 13, further including providing a setting interface on the display device to receive the user input.

15. The method according to claim 12, further including, prior to storing the spool file and the first parameter, deleting an oldest spool file and a first print parameter corresponding to the oldest spool file from the storage device when the number of spool files stored in the storage device is equal to or greater than a predetermined number.

16. The method according to claim 12, further including:
deleting the spool file and the first print parameter from the storage device after printing in response to receiving a delete request when the print request has been received; and
deleting the spool file and the second print parameter from the storage device after printing in response to receiving a delete request when the reprint request has been received.

17. The method according to claim 12, further including displaying a job interface including a first area and a second area in the display device, wherein the first area is configured to display information for a print job in a print queue and the second area is configured to display information for printed jobs.

18. The method according to claim 17, further including displaying the first print parameter in the display device when an object representing the printed job is dragged from the second area and dropped into the first area.

19. The method according to claim 17, wherein receiving the reprint request includes receiving user input dragging the printed job from the second area and dropping the printed job in the first area.

20. The method according to claim 17, wherein the information displayed in the second area includes a print date and time for the printed job.

21. A print system comprising:
a printing device;
a display device;
a storage device;
a processor operatively coupled to the printing device, the display device and the storage device; and
computer readable media for storing a set of computer instructions, which when executed by the processor, perform the steps of:
receiving a print request;
accepting a first print parameter associated with the print request;
generating a spool file based on the print request;
storing the spool file and the first print parameter in the storage device;
printing a first image, using the print device, based on the spool file and the first print parameter;
receiving a reprint request for printing a second image based on the spool file stored in the storage device;
retrieving the first print parameter from the storage device;
displaying the first print parameter in the display device;
generating a second print parameter from the first print parameter, the second print parameter being associated with the reprint request; and
printing the second image, using the print device, based on the second print parameter and the spool file.
